(19) United States
(12) Patent Application Publication
(10) Pub. No.: US 2026/0071948 A1
(43) Pub. Date: Mar. 12, 2026

(54) BIO CHIP FOR CELL ANALYSIS AND CELL ANALYSIS DEVICE USING SAME

(71) Applicant: PAXWELL CO.,LTD., Wonju-si, Gangwon-do (KR)

(72) Inventor: Dae Hee YI, Seoul (KR)

(73) Assignee: PAXWELL CO.,LTD., Wonju-si, Gangwon-do (KR)

(21) Appl. No.: 19/105,541

(22) PCT Filed: Oct. 28, 2022
(86) PCT No.: PCT/KR2022/016720

§ 371 Date: Feb. 21, 2025

(30) Foreign Application Priority Data
Aug. 24, 2022 (KR) 10-2022-0105960
Aug. 24, 2022 (KR) 10-2022-0105961

(51) Int. Cl. G01N 15/1404; G01N 15/01; G01N 15/10; G01N 15/14; G01N 15/1434

(52) U.S. Cl. CPC G01N 15/1404; G01N 15/01; G01N 15/1434; G01N 2015/1006; G01N 2015/1413; G01N 2015/142; G01N 2015/1486

(57) ABSTRACT

A bio-chip for cell analysis according to the present disclosure includes: a sample chamber configured to hold a sample; a first pump connected to one side of the sample chamber and configured to generate air pressure for discharging the sample in the sample chamber; a hydrodynamic coupling region connected to the sample chamber and a sheath-fluid supply channel through which the sheath fluid is supplied, configured so that the sample discharged from the sample chamber and the sheath fluid supplied through the sheath-fluid supply channel are mixed; and a bio-chip outlet channel configured so that the mixed sample and the sheath fluid are discharged from the hydrodynamic coupling region.

### TECHNICAL FIELD

The present disclosure relates to a bio-chip for cell analysis and a cell analysis device using the bio-chip. More particularly, the present disclosure relates to a bio-chip configured so that cell counting, cell characteristic analysis, and the like can be efficiently performed, and a cell analysis apparatus using the same.

### DESCRIPTION OF THE RELATED ART

In general, a bio-chip (bio-chip) refers to a chip in which biomaterials such as DNA, proteins, and cells are arranged in an array form on a substrate made of plastic, crystal (quartz), or glass, and which is used to check for the presence of substances that bond or react with the biomaterials. Recently, due to rapid developments in biotechnology, various immunodiagnostic or molecular diagnostic techniques are proposed, and the capacity to handle large amounts of genetic or protein information simultaneously has become important. Accordingly, technology related to bio-chips (bio-chips) is developing rapidly.

For example, a bio-chip may be implemented as a DNA chip, a protein chip, or a cell chip that only includes a chip having an array of biomaterials. As another example, a bio-chip may also be implemented as a lab-on-a-chip (LOC), configured such that after a sample is injected, microfluidic control is carried out within the chip to automatically perform analysis. A lab-on-a-chip may be implemented by BioMEMS technology, which allows fabrication of micrometer-scale structures based on semiconductor manufacturing technology. Furthermore, due to the miniaturized chip size, a lab-on-a-chip may reduce the volume of a sample required for analysis and thereby reduce experimental costs.

However, conventional bio-chip-based equipment either does not provide an efficient way to maintain fluid flow by means of microfluidic control or requires a large amount of additional equipment for continuous liquid supply. Moreover, there is a need for manufacturing devices that use complex processes in bio-chip fabrication, which may increase manufacturing costs.

Meanwhile, a flow cytometer is equipment that can rapidly measure particles or cells in a liquid state as they pass through a certain sensing point, simultaneously measuring various characteristics of the cells, such as cell size, the degree of internal cell composition, and the recognition of cell functions. Depending on the situation, the equipment may isolate (sort) particular cells after selection. In general, a flow cytometer has the characteristic of measuring and analyzing the cells of a target cell population one by one. In order to detect particles or cells in liquid form using a flow cytometer, fluorescent labeling by a fluorescent dye such as an antibody labeled with a certain wavelength of fluorescence is required. Also, an LED or a laser light source is used as a method to detect fluorescence. For example, when a certain wavelength of light is irradiated onto a cell labeled with fluorescence, light at an energy level lower than that of the irradiated light may be generated from the cell. For instance, when 488 nm blue light is used for irradiation, a cell labeled with FITC may generate 520 nm green light.

Conventional flow cytometers use complex optical systems or cell characteristic detection and analysis components, such as laser or LED emitters of various wavelengths, a light receiving unit that measures forward scatter after irradiating cells with light, and other light receiving units of various wavelengths that measure side scatter. Accordingly, manufacturing and maintaining such analyzers require significant cost and effort. Therefore, small businesses or laboratories find it burdensome to carry out biotechnology-related tasks or research activities using existing flow cytometers.

### DISCLOSURE

### Technical Problem

Embodiments disclosed herein provide a bio-chip configured so that cell counting, cell characteristic analysis, and the like may be efficiently performed, and a cell analysis apparatus using the same. In particular, some embodiments of the present disclosure provide a bio-chip and a cell analysis apparatus using the same, capable of precise cell analysis by utilizing both side scatter and forward scatter generated from the light irradiated onto a cell sample to be measured.

### Technical Solution

The present disclosure may be implemented in various forms including devices and methods.

A bio-chip for cell analysis according to one embodiment of the present disclosure may include: a sample chamber configured to hold a sample; a first pump connected to one side of the sample chamber and configured to generate air pressure for discharging the sample in the sample chamber; a hydrodynamic coupling region connected to the sample chamber and a sheath-fluid supply channel through which the sheath fluid is supplied, so that the sample discharged from the sample chamber and the sheath fluid supplied through the sheath-fluid supply channel may be mixed; and a bio-chip discharge channel configured to discharge the mixed sample and sheath fluid from the hydrodynamic coupling region.

According to one embodiment, the system may further include a sheath-fluid chamber connected to the sheath-fluid supply channel and configured to hold a sheath fluid. Additionally, a second pump connected to one side of the sheath-fluid chamber is configured to generate air pressure to discharge the sheath fluid in the sheath-fluid chamber toward the hydrodynamic coupling region through the sheath-fluid supply channel.

According to one embodiment, an acoustic vibration element configured to generate acoustic vibrations toward the hydrodynamic coupling region may be further included.

According to one embodiment, a laser light source configured to irradiate laser light toward at least one of the sample chamber, the hydrodynamic coupling region, and the sample discharge channel may be further included.

According to one embodiment, the laser light source may include: a first laser light source for irradiating sheet-shaped laser light toward a side surface of the sample chamber; a second laser light source for irradiating laser light toward a side surface of the hydrodynamic coupling region; and a third laser light source for irradiating laser light toward a side surface of the sample discharge channel.

According to one embodiment, the first laser light source may include: a laser diode that generates laser light; an aspheric lens that refracts the laser light; and a cylinder lens that converges the laser light and irradiates a sheet of light toward the sample chamber.

According to one embodiment, the bio-chip discharge channel may be configured such that at least part of its width becomes narrower in the direction in which the sample is discharged.

According to one embodiment, a photo sensor for capturing scattered light generated from at least one of the sample chamber, the hydrodynamic coupling region, and the bio-chip discharge channel may be further included.

According to one embodiment, the photo sensor may include: a first photo sensor for detecting forward scatter generated by the sheet-shaped light irradiated onto the sample in the sample chamber; a second photo sensor for detecting either the combination status of the sheath fluid and the sample in the hydrodynamic coupling region or forward scatter generated by the laser light; and a third photo sensor for detecting the sample discharged through the bio-chip discharge channel or forward scatter generated by the laser light.

Another embodiment of the present disclosure provides a cell analysis method using a bio-chip, which may include: supplying a sample to a sample chamber; supplying a sheath fluid to a sheath-fluid chamber; discharging the sample in the sample chamber to a hydrodynamic coupling region by a first pump; discharging the sheath fluid in the sheath-fluid chamber to the hydrodynamic coupling region by a second pump, discharging the mixed sample and sheath fluid from the hydrodynamic coupling region by a bio-chip discharge channel; and, by means of a laser light source and a photo sensor, detecting the number of cells or the cell status at least in one of the sample chamber, the hydrodynamic coupling region, and the bio-chip discharge channel.

A cell analysis apparatus using a bio-chip according to one embodiment of the present disclosure may include: a bio-chip that has a sample chamber configured to hold a sample; a hydrodynamic coupling region connected to the sample chamber and a sheath-fluid supply channel, configured so that cells emerging from a channel (flow path) connected to the sample chamber and the sheath fluid supplied through the sheath-fluid supply channel (flow path) are mixed; and a bio-chip outlet configured so that the mixed sample and sheath fluid in the coupling region are discharged; one or more laser light sources configured to irradiate laser light from the side of the bio-chip toward at least one of the sample chamber, the hydrodynamic coupling region, and the bio-chip outlet channel; and one or more photo sensors configured to capture the scattered light generated from at least one of the sample chamber, the hydrodynamic coupling region, and the bio-chip outlet channel by irradiation of the laser light.

According to one embodiment, the bio-chip may further include a sheath-fluid chamber connected to the sheath-fluid supply channel and configured to hold the sheath fluid.

According to one embodiment, an LED light source that irradiates light toward an upper surface of the bio-chip and an image sensor located on a lower surface of the bio-chip may be further included.

According to one embodiment, a pinhole may be further included, positioned between the bio-chip and the LED light source, and configured to limit the range of light irradiation.

According to one embodiment, one or more light receiving elements for detecting side scatter generated on the upper surface of the bio-chip by the one or more laser light sources may be further included.

According to one embodiment, the image sensor may be configured to detect side scatter or fluorescence generated on the lower surface of the bio-chip by the one or more laser light sources, or to detect a dark-field image or a bright-field or absorption image generated on the lower surface of the bio-chip by the light irradiated from the LED light source.

Another cell analysis method using a bio-chip according to the present disclosure may include: preparing a bio-chip having a sample chamber configured to hold a sample, a sheath-fluid chamber configured to hold the sheath fluid, a hydrodynamic coupling region connected to both the sample chamber and the sheath-fluid chamber so that the channels (flow paths) extending from the sample chamber and the sheath-fluid chamber and the sheath fluid are mixed, and a bio-chip outlet configured so that the sample and the sheath fluid mixed in the hydrodynamic coupling region are discharged; irradiating laser light from the side of the bio-chip toward at least one of the sample chamber, the hydrodynamic coupling region, and the bio-chip outlet channel by one or more laser light sources; and capturing scattered light generated from at least one of the sample chamber, the hydrodynamic coupling region, and the bio-chip outlet channel due to the irradiation by the one or more laser light sources by one or more photo sensors.

### Advantageous Effects

According to various embodiments of the present disclosure, the bio-chip for cell analysis may include a pump or a vibration element to induce mixing of a cell sample and sheath fluid, thereby achieving efficient microfluidic control.

According to various embodiments of the present disclosure, it has an optimized structure enabling cell analysis using a cell analysis apparatus of a relatively simple configuration and functionality.

According to various embodiments of the present disclosure, the bio-chip for cell analysis has an optimized structure for more precise cell analysis by utilizing forward and side scatter generated by light irradiation of the cell sample under analysis.

According to various embodiments of the present disclosure, the cell analysis apparatus has an optimized structure allowing cell analysis by using a bio-chip of relatively simple configuration and functionality, together with a cell detection sensor.

According to various embodiments of the present disclosure, a cell analysis apparatus using a bio-chip may selectively or comprehensively analyze various characteristics of a cell sample by using forward scatter and side scatter generated by light irradiation onto the cell sample to be analyzed.

According to various embodiments of the present disclosure, it is possible to efficiently detect fluorescence emission by the laser light source using an image sensor and an optical sensor closely arranged with respect to the bio-chip, without installing a complex optical system in the cell analysis apparatus.

The effects of the present disclosure are not limited to those mentioned above, and other effects not mentioned will be clearly understood by those skilled in the art from the following descriptions.

### BRIEF DESCRIPTION OF DRAWINGS

FIG. 1 is a diagram illustrating an example of a bio-chip for cell analysis according to one embodiment of the present disclosure.

FIG. 2 is a diagram illustrating an example of a bio-chip for cell analysis according to another embodiment of the present disclosure.

FIG. 3 is a diagram illustrating an example of a cell analysis apparatus using a bio-chip for cell analysis according to one embodiment of the present disclosure.

FIG. 4 is a diagram illustrating detailed configurations of an optical system for generating sheet-shaped light from a first laser light source according to one embodiment of the present disclosure.

FIG. 5 is a diagram illustrating a detailed structure of the sample discharge channel of a bio-chip according to one embodiment of the present disclosure.

FIG. 6 is a flowchart illustrating a cell analysis method using a bio-chip according to one embodiment of the present disclosure.

FIG. 7 is a diagram illustrating a cell analysis apparatus for capturing and analyzing cell images by means of an LED light source, according to one embodiment of the present disclosure.

FIG. 8 is a diagram illustrating a cell analysis apparatus for detecting side scatter generated from a cell by laser light, according to one embodiment of the present disclosure.

FIG. 9 is a diagram illustrating a spectrum of fluorescence excited or scattered from cells stained with various fluorescent dyes or fluorescent substances in a bio-chip, when laser light is irradiated toward the bio-chip in a cell analysis apparatus according to one embodiment of the present disclosure.

FIG. 10 is a diagram illustrating a cell analysis method using a bio-chip according to one embodiment of the present disclosure.

### DETAILED DESCRIPTION

Hereinafter, specific details for implementing the present disclosure will be described in detail with reference to the attached drawings. However, in the following description, if there is a concern that the essence of the present disclosure could be unnecessarily blurred, detailed descriptions of well-known functions or configurations may be omitted.

In the attached drawings, the same reference numerals have been assigned to identical or corresponding components. Also, in the descriptions of the following embodiments, repeated descriptions of identical or corresponding components may be omitted. However, even if the description regarding a component is omitted, it is not intended to exclude that component from any embodiment.

The advantages and features of the disclosed embodiments, and methods of achieving them, will become apparent by referring to the embodiments described below in conjunction with the accompanying drawings. However, the present disclosure is not limited to the embodiments disclosed below and may be implemented in various different forms. The embodiments are provided only to make the present disclosure complete and to fully inform those skilled in the art of the scope of the invention.

A brief explanation of terms used in the present disclosure will be given, followed by a detailed description of the disclosed embodiments. The terms used herein were chosen, to the extent possible, from among widely used general terms in consideration of the functions in the present disclosure, but they may vary according to the intentions of those skilled in the art, judicial precedents, or the emergence of new technologies, etc. In some cases, certain terms may be arbitrarily selected by the applicant, in which case the meaning thereof will be described in detail in the description of the pertinent invention. Therefore, the terms used in the present disclosure should not be construed merely as the names of the terms but should be defined based on the meaning of the terms and the overall content of the present disclosure.

In this specification, expressions in the singular number include the plural unless the context clearly indicates a singular meaning. Likewise, expressions in the plural number include the singular unless the context clearly indicates a plural meaning. Throughout this specification, when a part is said to “include” a particular component, this means that it may further include other components, not that it necessarily excludes other components, unless specifically stated otherwise.

In the present disclosure, the upper side of the drawings may be referred to as the top or upper side of the illustrated structure, and the lower side may be referred to as the bottom or lower side. Also, in the drawings, a region between the top and bottom of the illustrated structure, or any remaining portion besides the top and bottom, may be referred to as a side or a lateral side. Such relative terms such as “top” or “upper side” may be used to describe the relationship among structures illustrated in the drawings, and the present disclosure is not limited by such terms.

In this specification, the recitation “A and/or B”means A, or B, or A and B.

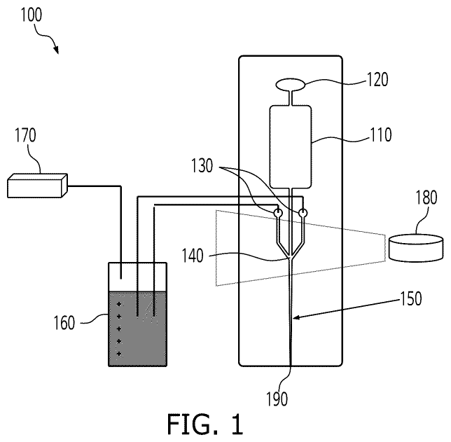

FIG. 1 is a diagram illustrating an example of a bio-chip 100 for cell analysis according to one embodiment of the present disclosure. The bio-chip 100 may be a bio-chip included in a cell analysis apparatus that executes cell counting, cell characteristic analysis, and the like. Also, the bio-chip 100 may be implemented by a microchip or MEMS or BioMEMS technology having one or more microchannels connecting a sample chamber, a sheath-fluid chamber, etc., in order to perform microfluidic control for cell analysis, but is not limited thereto.

As shown, the bio-chip 100 may include: a sample chamber 110 that holds an analysis-target sample (for example, a biomaterial such as cells, proteins, etc.), and a sample inlet 120 connected to the sample chamber 110 and configured to inject the sample, which includes a first pump (not shown) for inducing fluid movement of the sample. In addition, the bio-chip 100 may include a sheath-fluid inlet 130 into which sheath fluid is injected and a hydrodynamic coupling region 140, which is connected via microchannels to each of the sample chamber 110 and the sheath-fluid inlet 130 and is configured to mix the sample and the sheath fluid. Further, the bio-chip 100 may include an acoustic vibration element 180 for inducing the combination of the sample and the sheath fluid in the hydrodynamic coupling region 140, and a bio-chip outlet channel 150 configured so that the mixed sample and sheath fluid are discharged from the hydrodynamic coupling region 140. Meanwhile, a sheath-fluid chamber 160, configured to hold sheath fluid and supply it via the sheath-fluid inlet 130, may be connected to the sheath-fluid inlet 130. Also, a second pump 170 for inducing fluid movement of the sheath fluid (for example, discharging the sheath fluid from the sheath-fluid chamber 160 to the sheath-fluid inlet 130) may be connected to the sheath-fluid chamber 160.

The sample chamber 110 is configured to hold a sample and may, overall, have a generally rectangular shape with a thickness smaller than that of the bio-chip 100, but is not limited thereto. For example, the sample chamber 110 may be implemented in another shape such as a polygon, a circle, or an ellipse that is not rectangular. Further, one side of the sample chamber 110 may be connected through a microchannel to the sample inlet 120 that supplies the sample. The sample may be injected through the sample inlet 120 by a separate sample supply device such as a pipette. Also, a first pump (not shown) may be connected to or installed in the sample inlet 120. For instance, the first pump may generate air pressure and supply it to the sample inlet 120, so that the sample in the sample chamber 110 is induced to be discharged or moved to the outside. Through such a configuration, the sample supplied to the sample chamber 110 via the sample inlet 120 may be effectively discharged from the sample chamber 110 toward the hydrodynamic coupling region 140 by the first pump. For example, the first pump may be a micro-pump or a piezoelectric pump implemented using MEMS technology.

The sheath-fluid inlet 130 may include an opening for injecting the sheath fluid.

When the sheath fluid is injected through the sheath-fluid inlet 130, that sheath fluid may be discharged through a microchannel (i.e., a sheath-fluid supply channel) into the hydrodynamic coupling region 140. The sheath fluid discharged into the hydrodynamic coupling region 140 in this manner may be mixed in the hydrodynamic coupling region 140 with the sample discharged from the sample chamber 110. Further, the sample and sheath fluid mixed in the hydrodynamic coupling region 140 may be discharged to the outside of the bio-chip 100 via a bio-chip outlet 190.

According to one embodiment, as shown in FIG. 1, a sheath-fluid chamber 160 and a second pump 170 may be installed outside the bio-chip 100. The sheath-fluid chamber 160 may be manufactured or provided separately from the bio-chip 100 and connected outside the bio-chip 100 to the sheath-fluid inlet 130 through a channel or path for supplying sheath fluid. Further, the second pump 170 may be connected to one side of the sheath-fluid chamber 160. The second pump 170 may generate air pressure to supply the sheath fluid in the sheath-fluid chamber 160 to the sheath-fluid inlet 130. For example, the second pump 170 may be a micro-pump or a piezoelectric pump implemented using MEMS technology. Although in FIG. 1 the sheath-fluid chamber 160 is illustrated approximately in a square shape, its shape is not so limited. For instance, the sheath-fluid chamber 160 may have a shape other than a square, such as another polygon, a circle, or an ellipse.

The acoustic vibration element 180 may generate vibrations or acoustic waves to induce the combination of the sample and the sheath fluid. The acoustic vibration element 180 is arranged to generate acoustic vibrations toward the hydrodynamic coupling region 140. In that case, by means of acoustic vibrations, the sample and sheath fluid supplied from the sample chamber 110 and the sheath-fluid chamber 160 to the hydrodynamic coupling region 140 are effectively repeatedly collided with each other and arranged, and may be discharged in a linearly aligned state through the bio-chip outlet 190, and may be discharged in a linearly aligned state through the bio-chip outlet 190. For example, the acoustic vibration element 180 may include a piezoelectric vibration element or an acoustic speaker implemented using MEMS technology. According to the above configuration, the sample and sheath fluid supplied to the hydrodynamic coupling region 140 collide with each other and mix by the acoustic vibrations generated by the acoustic vibration element 180, and among them, the sample is aligned in a line within the sheath fluid and discharged through the bio-chip outlet channel 150.

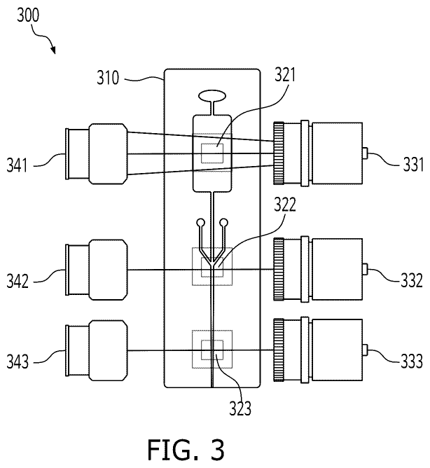

FIG. 1 shows a planar configuration of the bio-chip 100 viewed from above; however, the side surface of the bio-chip 100 may be processed as a flat surface to prevent optical distortion. That is, in order to prevent optical distortion in laser light irradiation or forward scatter caused by laser light to be described below with reference to FIG. 3, a flat finishing or surface processing step may be applied to the side surface of the bio-chip 100.

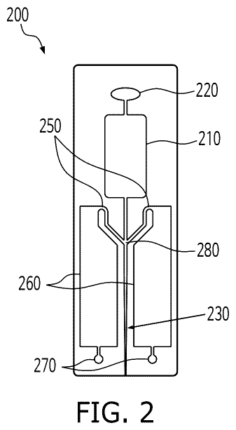

FIG. 2 is a diagram illustrating an example of a bio-chip 200 for cell analysis according to another embodiment of the present disclosure. The bio-chip 200 may be a bio-chip included in a cell analysis apparatus that executes cell counting, cell characteristic analysis, and the like. Also, the bio-chip 200 may be implemented by a microchip or MEMS or BioMEMS technology, having one or more microchannels connecting a sample chamber, a sheath-fluid chamber, and so on, in order to perform microfluidic control for cell analysis, but is not limited thereto.

As shown, the bio-chip 200 may include a sheath-fluid chamber 260 within the bio-chip 200. A sample chamber 210 of the bio-chip 200 may be configured to accommodate a sample. The bio-chip 200 may include a sample chamber 210 for accommodating the analysis-target sample (for example, a biomaterial such as cells or proteins), and a sample inlet 220 connected to the sample chamber 210 and configured to inject the sample, including a first pump (not shown) for inducing fluid movement of the sample.

The first pump may generate air pressure and supply it toward the sample chamber 210, so that the sample in the sample chamber 210 is guided by the air pressure to move toward the hydrodynamic coupling region 280. Furthermore, when the first pump operates, air pressure may be delivered through the bio-chip outlet channel 230 continuously connected to the sample chamber 210 and the hydrodynamic coupling region 280, and accordingly, the sample in the hydrodynamic coupling region 280 may be discharged through the bio-chip outlet channel 230.

The sheath-fluid chamber 260 may be formed inside the bio-chip 200. The sheath-fluid chamber 260 is configured to hold a predetermined volume of sheath fluid and may, overall, have a substantially rectangular or polygonal shape with a thickness smaller than that of the bio-chip 200, but is not limited thereto. A sheath-fluid inlet 270 may be formed on one side of the sheath-fluid chamber 260. The sheath fluid may be injected through the sheath-fluid inlet 270 using a separate liquid supply device such as a pipette. In addition, a second pump (not shown) may be connected to or installed at the sheath-fluid inlet 270. The second pump may generate air pressure so that the sheath fluid in the sheath-fluid chamber 260 is discharged into the hydrodynamic coupling region 280. While the sheath fluid is discharged into the hydrodynamic coupling region 280, the sample in the sample chamber 210 may also be discharged into the hydrodynamic coupling region 280 according to the air pressure of the first pump. The sample and sheath fluid discharged into the hydrodynamic coupling region 280 collide with each other due to acoustic vibrations by an acoustic vibration element (not shown) and are mixed. The samples in the sheath fluid become aligned in a line and may be discharged to the outside through the bio-chip outlet channel 230.

In addition, FIG. 2 shows a planar configuration of the bio-chip 200 from above, but the side surface of the bio-chip 200 may be processed as a flat surface to prevent optical distortion. That is, in order to prevent optical distortion during laser light irradiation or forward scatter caused by laser light described below with reference to FIG. 3, a flat finishing or surface treatment process may be applied to the side surface of the bio-chip 200.

FIG. 3 is a diagram illustrating an example of a cell analysis apparatus 300 using a bio-chip 310 for cell analysis according to one embodiment of the present disclosure. As illustrated, the cell analysis apparatus 300 may include laser light sources 331, 332, 333 that irradiate laser light toward the bio-chip 310, and photo sensors 341, 342, 343 that capture scattered light generated by the irradiation of laser light onto the bio-chip 310. Meanwhile, the bio-chip 310 may include a sample chamber 321 for holding the sample, a hydrodynamic coupling region 322 connected to the sample chamber 321 and containing the sample mixed with sheath fluid, and a bio-chip outlet channel 323 from which the sample and the sheath fluid are discharged from the hydrodynamic coupling region 322.

The laser light sources 331, 332, 333 may include: a first laser light source 331 for irradiating cross-sectional laser light toward a side surface of the sample chamber 321; a second laser light source 332 for irradiating laser light toward a side surface of the hydrodynamic coupling region 322; and a third laser light source 333 for irradiating laser light toward a side surface of the bio-chip outlet channel 323. In FIG. 3, the laser light sources 331, 332, 333 are shown to include three light sources, but they are not limited thereto. Depending on the design requirements of the cell analysis apparatus 300, the laser light sources 331, 332, 333 may include one or two light sources.

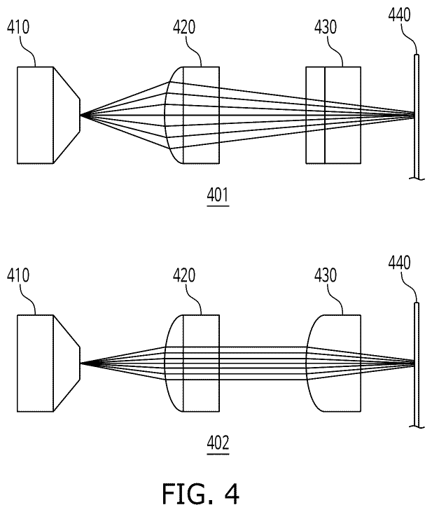

The first laser light source 331 may irradiate a laser sheet beam having a predetermined cross-sectional shape (for example, a narrow, elongated rectangle) toward the side surface of the sample chamber 321. When the sheet beam is irradiated onto the sample in the sample chamber 321, forward scatter may be generated. Here, the sample may be a sample pre-stained with a fluorescent material. In one embodiment, the first laser light source 331 may generate a sheet beam having a wavelength of 488 nm. The internal structure of the first laser light source 331 will be further described below with reference to FIG. 4.

The second laser light source 332 may irradiate laser light toward the side surface of the hydrodynamic coupling region 322. The second laser light source 332 may irradiate laser light onto the sample and sheath fluid in the hydrodynamic coupling region 322 to generate forward scatter and side scatter from at least one of the sample or the sheath fluid. In one embodiment, the second laser light source 332 may be a point-type laser beam having a wavelength of 488 nm.

The third laser light source 333 may irradiate laser light toward the side surface of the bio-chip outlet channel 323. The third laser light source 333 may irradiate laser light onto the sample and sheath fluid moving in a line through the bio-chip outlet channel 323, thus generating forward and side scatter therefrom. In addition, the third laser light source 333 may use a wavelength different from that of the second laser light source 332 in order to detect a fluorescent material not detected by the laser light irradiation of the second laser light source 332. In one embodiment, the third laser light source 333 may be a point-type laser beam having a wavelength of 355 nm, 488 nm, or 638 nm.

The photo sensors 341, 342, 343 may be configured to detect the scattering of light generated by the laser light sources 331, 332, 333. The photo sensor may be implemented as an image sensor, a CMOS sensor, or the like.

The photo sensors 341, 342, 343 may include a first photo sensor 341 for detecting forward scatter generated by the sheet beam irradiated onto the sample chamber 321. In addition, the photo sensors 341, 342, 343 may include a second photo sensor 342 for detecting the combined state of the sample and sheath fluid in the hydrodynamic coupling region 322 or detecting forward scatter generated by laser light irradiated onto the sample and sheath fluid. The photo sensors 341, 342, 343 may include a third photo sensor 343 for detecting the mixed sample and sheath fluid arranged in a line and discharged through the bio-chip outlet channel 323 or detecting forward scatter generated by the laser light irradiated onto the sample and sheath fluid.

FIG. 3 shows a planar configuration of the bio-chip 310 inserted into the cell analysis apparatus 300 as viewed from above; however, the side surface of the bio-chip 310 may be processed as a flat surface to prevent optical distortion. That is, in order to prevent optical distortion during irradiation of the laser light from the laser light sources 331, 332, 333 or detection of forward scatter generated by the laser light by the photo sensors 341, 342, 343, a flat finishing or surface processing procedure (known as a surface-grinding process) may be applied to the side surface of the bio-chip 310.

FIG. 4 is a diagram illustrating the detailed configuration of an optical system for generating sheet-shaped light from a first laser light source according to one embodiment of the present disclosure. A first arrangement 401 shows a plan view (i.e., an X-Z plane view) of the optical system for generating sheet-shaped light from the first laser light source. A second arrangement 402 shows a side view (i.e., a Y-Z plane view) of the optical system for generating sheet-shaped light from the first laser light source.

As shown, the optical system may include a laser diode 410, an aspheric lens 420, and a cylinder lens 430. The laser diode 410 may be a light source configured to generate diffuse laser light.

In one embodiment, although the light source of the optical system is shown as the laser diode 410, the light source may be another suitable type such as a high-brightness LED that can generate laser light. The light emitted from the laser diode 410 has two different divergence angles (for example, a divergence angle along the fast axis and a divergence angle along the slow axis). In the first arrangement 401, the laser diode 410 is positioned such that the fast axis is aligned along the X-Z plane, causing the divergence angle on the X-Z plane to become relatively larger. In contrast, in the second arrangement 402, the laser diode 410 is positioned so that the slow axis is along the Y-Z plane, resulting in a relatively smaller divergence angle on the Y-Z plane. Comparing the light emitted from the laser diode 410 toward the aspheric lens 420 between the first arrangement 401 and the second arrangement 402, one finds that in the first arrangement 401 the light diverges more quickly relative to the second arrangement 402, and that the X-Z plane has a larger divergence angle than the Y-Z plane. This alignment of the divergence angle of the laser light may be related to the alignment of the cylinder lens 430.

The laser light generated by the laser diode 410 may be irradiated toward the aspheric lens 420. The aspheric lens 420 may refract the diffuse laser light and converge it within a certain range. In general, a spherical lens does not converge exactly into a single point, generating spherical aberration. The aspheric lens 420 is used to reduce such spherical aberration.

In addition, the cylinder lens 430 may focus the refracted laser light into a single line or straight line, converting it into a long rectangular shape or line-shaped cross-sectional beam. In one embodiment, in the first arrangement 401, since the divergence angle of the laser diode 410 is larger than that in the second arrangement 402, tertiary aberration effects dominate. As a result, the marginal rays and paraxial rays do not focus at the same point, causing intensity redistribution. On the other hand, in the second arrangement 402, aberration occurs much less due to the orientation of the divergence angle of the laser diode 410, forming a well-focused point via the cylinder lens 430. Consequently, with the cylinder lens 430, the cross-sectional light portion can be compressed in the thickness direction of the cross-section. Due to the combined effect of the uniform focal points of the laser light in the first arrangement 401 and the second arrangement 402, the beam may be irradiated toward the side surface of the bio-chip 440.

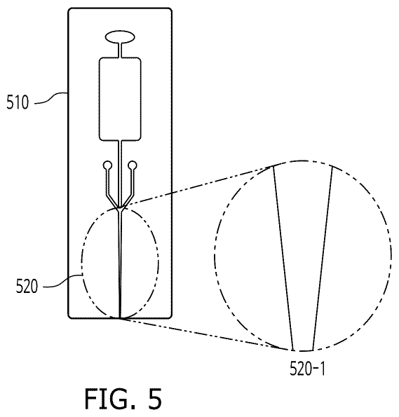

FIG. 5 is a diagram illustrating a detailed structure of a bio-chip outlet channel 520 of a bio-chip 510 according to one embodiment of the present disclosure. The bio-chip outlet channel 520 of the bio-chip 510 may be configured so that its width becomes narrower in the lengthwise direction toward the lower end of the bio-chip 510.

For example, after the sample and the sheath fluid are mixed in the hydrodynamic coupling region connected to the bio-chip outlet channel 520, the mixed sample and sheath fluid may flow through the bio-chip outlet channel 520. When the mixed sample and sheath fluid are discharged through the bio-chip outlet channel 520, the sample surrounded by the sheath fluid may move one drop at a time while linearly aligned, and thus be detected by the cell analysis apparatus with higher precision or accuracy.

As shown, the bio-chip outlet channel 520 may include a tapered portion in which the upper portion connected to the hydrodynamic coupling region is formed wide, and a certain portion toward the lower side gradually narrows in width. Also, after the tapered portion, the bio-chip outlet channel 520 may have a uniform width. By configuring at least part of the bio-chip outlet channel 520 so that the width gradually narrows, the sample mixed with the sheath fluid in the hydrodynamic coupling region may be gradually aligned in a line in the tapered portion of the bio-chip outlet channel 520, and thereafter that state may be maintained consistently beyond the tapered portion.

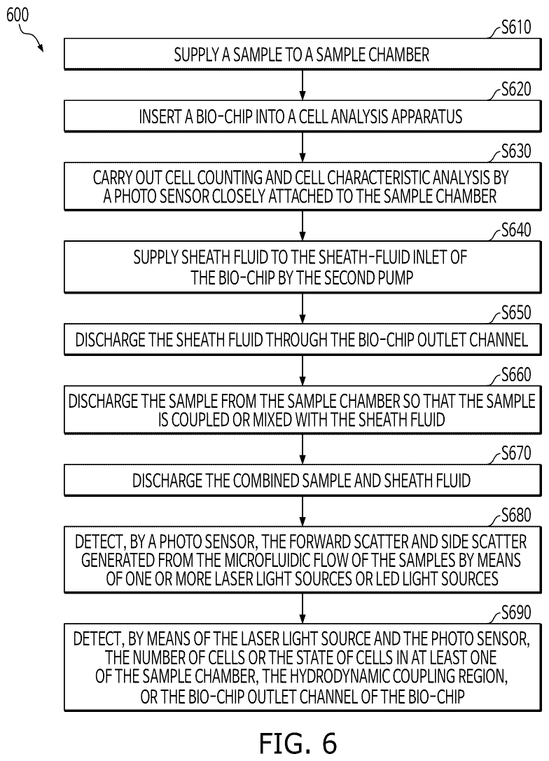

FIG. 6 is a flowchart illustrating a cell analysis method using a bio-chip according to one embodiment of the present disclosure. A method 600 for analyzing cells using a bio-chip may begin with supplying a sample to a sample chamber (S610). For example, an experimenter or a bio-chip user may inject a sample into the cell inlet of the bio-chip using a pipette. The sample injected into the bio-chip may be discharged into the sample chamber by the air pressure of the first pump connected to the cell inlet.

Next, the bio-chip may be inserted into the cell analysis apparatus (S620). Once the bio-chip is inserted into the cell analysis apparatus, cell counting and cell characteristic analysis for the bio-chip may be carried out by a photo sensor closely attached to the sample chamber (S630). The photo sensor may include an image sensor, a camera, etc. The photo sensor may capture images of samples in the bio-chip. The captured sample images may be used for cell counting (stationary cells) and cell characteristic analysis based on hemocytometry.

Next, the sheath fluid may be supplied to the sheath-fluid inlet of the bio-chip by the second pump (S640). When the sheath fluid is supplied, it may move through the sheath-fluid supply channel to the hydrodynamic coupling region and be discharged through the bio-chip outlet channel (S650). In this way, once the sheath fluid is discharged through the sheath-fluid supply channel, the hydrodynamic coupling region, and the bio-chip outlet channel of the bio-chip, all other regions and channels of the bio-chip apart from the sample chamber may be washed clean. After carrying out such a channel-cleaning process by the sheath fluid in the bio-chip, cell analysis may begin.

By means of the first pump, the sample is discharged from the sample chamber to a connected channel (flow path), and the sample may be coupled or mixed with the sheath fluid in the hydrodynamic coupling region (S660). In other words, the sample in the sample chamber may be moved to the hydrodynamic coupling region by the first pump. Also, the sheath fluid in the sheath-fluid chamber may be discharged to the hydrodynamic coupling region by the second pump. In the hydrodynamic coupling region, the sample and the sheath fluid may be effectively combined by the acoustic vibration element.

Once the sample and the sheath fluid are combined, the combined sample and sheath fluid may be discharged (S670). The combined sample and sheath fluid may be discharged to the outside through the bio-chip outlet channel by the acoustic vibration element. The acoustic vibration element may generate acoustic vibrations so that the sample and the sheath fluid collide with each other, causing the samples to align in a line within the sheath fluid.

The acoustic vibration element may be configured with a piezoelectric element or a speaker, etc. Also, by means of the bio-chip outlet channel, the sample and the sheath fluid mixed in the hydrodynamic coupling region may be discharged to the outside.

In accordance with the microfluidic flow of the samples formed in the bio-chip having the above-described configuration, the forward scatter and side scatter generated from the microfluidic flow of the samples by means of one or more laser light sources or LED light sources are detected by a photo sensor arranged according to the microfluidic flow of the samples (S680). In other words, by a flow cytometry technique that detects forward or side scatter of laser light or LED light irradiated to the microfluidic flow of samples formed in the bio-chip, counting of the flow cells and analyzing the cell characteristics may be carried out.

In addition, by means of the laser light source and the photo sensor, the number of cells or the state of cells may be detected in at least one of the sample chamber, the hydrodynamic coupling region, or the bio-chip outlet channel of the bio-chip (S690). Referring to FIG. 3 in one embodiment, the first laser light source may irradiate sheet-shaped light onto the sample chamber. The first photo sensor may detect forward scatter generated from the sample in the sample chamber by the sheet beam irradiation. Next, the second laser light source may irradiate laser light onto the hydrodynamic coupling region in which the sample and sheath fluid are mixed. Because of the laser light irradiation, forward and side scatter may occur in the hydrodynamic coupling region, and the forward scatter may be detected by the second photo sensor. Also, the second photo sensor may detect the mixing state of the sample and the sheath fluid in the hydrodynamic coupling region. Finally, the third laser light source may irradiate laser light onto the bio-chip outlet channel. The third photo sensor may detect forward scatter and side scatter generated at the bio-chip outlet or bio-chip outlet channel due to the laser light irradiation, and may detect sample characteristics such as the arrangement or flow of the sample in the bio-chip outlet channel.

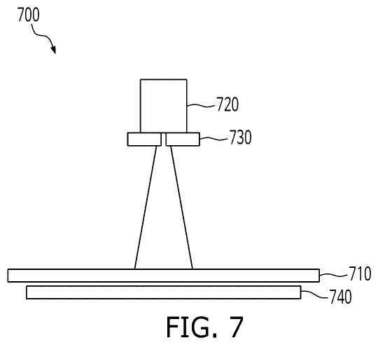

FIG. 7 is a diagram illustrating a cell analysis apparatus 700 for capturing and analyzing images of cells by means of an LED light source, according to one embodiment of the present disclosure. As shown, the cell analysis apparatus 700 may include an LED light source 720 for irradiating light toward the upper surface of the bio-chip 710, a pinhole 730 for controlling the coherence and brightness of the light irradiated from the LED light source 720, and an image sensor 740 disposed on the lower surface of the bio-chip 710 to detect the images of cells generated by the light irradiated from the LED light source 720 toward the bio-chip 710. For example, the bio-chip 710 may have the same configuration as the bio-chip 110 shown in FIG. 1.

The LED light source 720 may be located on the top side of the bio-chip 710 so as to irradiate LED light toward the bio-chip 710. For example, the LED light source may be a UV (ultraviolet) light source, a source that generates visible light, or a source that generates infrared light. The light irradiated from the LED light source 720 toward the bio-chip 710 may generate a dark-field or bright-field image, a shadow image, or an absorption image of cells (or cells in a liquid state) contained in the bio-chip 710, or may generate fluorescence, forward scatter, and/or side scatter. For instance, a shadow image or forward scatter may be detected by the image sensor 740 disposed on the lower surface of the bio-chip 710, whereas side scatter may be detected by one or more photo sensors as shown in FIG. 1.

The pinhole 730 may be positioned between the bio-chip 710 and the LED light source 720 and configured to control the coherence, brightness, range, etc. of the light irradiated from the LED light source 720. The hole of the pinhole 730 may be a microscopic aperture of nm to um scale. For example, the pinhole 730 may be used during dark-field imaging and may be separated from the LED light source 720 or moved to the side of the LED light source 720 for bright-field imaging.

The image sensor 740 may be placed near the lower surface of the bio-chip 710. For example, the image sensor 740 may be implemented as a CMOS (complementary metal-oxide semiconductor) image sensor or a CCD (charge-coupled device) sensor. The image sensor 740 may detect a shadow image or scattered light of cells, which is generated by the LED light source 720, or detect lateral scattered light generated by the laser light source shown in FIG. 1.

FIG. 7 shows that in the cell analysis apparatus 700, the LED light source 720 and the image sensor 740 are respectively arranged on the upper side and lower side of the bio-chip 710, but this is not limiting. One side of the bio-chip 710 may be provided with one or more laser light sources as shown in FIG. 1, and the other side of the bio-chip 710 opposite thereto may be provided with one or more photo sensors.

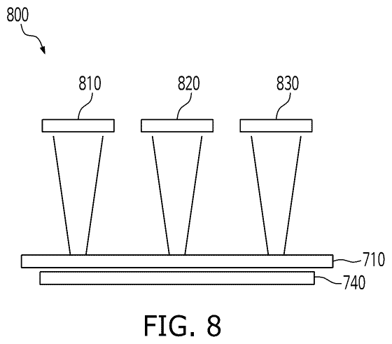

FIG. 8 is a diagram illustrating a cell analysis apparatus 800 for detecting side scatter generated from a cell by laser light, according to one embodiment of the present disclosure. As shown, the cell analysis apparatus 800 may include one or more light receiving elements 810, 820, 830 arranged above the bio-chip 710, configured to detect side scatter generated from cells contained in the bio-chip 710 by a laser light source. In this case, the laser light source may be placed on the side surface of the bio-chip 710 so as to irradiate sheet-shaped or point-shaped laser light toward the side surface of the bio-chip 710. The one or more light receiving elements 810, 820, 830 may be arranged on the upper side of the bio-chip 710 so as to detect side scatter generated at the upper surface of the bio-chip 710 when the laser light source irradiates laser light toward the side surface of the bio-chip 710. For example, the bio-chip 710 may have the same configuration as the bio-chip 110 shown in FIG. 1.

The image sensor 740 may be arranged near the lower surface of the bio-chip 710. For example, the image sensor 740 may be implemented as a CMOS image sensor. The image sensor 740 may detect the shadow image of cells generated by the LED light source or the side scatter of cells generated by the laser light source.

In FIG. 3, three light receiving elements 810, 820, 830 are shown, but the configuration is not limited thereto, and any number of light receiving elements may be included. For example, the light receiving elements 810, 820, 830 may use optical sensors such as PMT (photomultiplier), MPPC (multi-pixel photon counter), or SiPM (silicon photomultiplier) that have high detection performance in order to observe the sample more precisely than an image sensor.

Also, in FIG. 3, it is shown that in the cell analysis apparatus 800, the light receiving elements 810, 820, 830 and the image sensor 740 are respectively arranged on the upper side and the lower side of the bio-chip 710, but this is not limiting. One or more laser light sources as shown in FIG. 1 may be installed on one side of the bio-chip 710, and one or more photo sensors may be installed on the other side of the bio-chip 710 facing it.

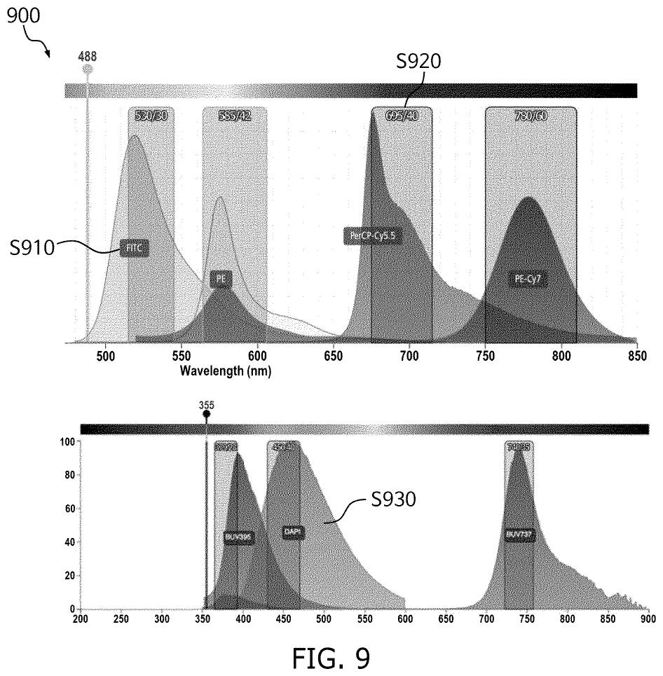

FIG. 9 is a diagram showing the spectrum 900 of fluorescence that is excited or scattered from cells stained with various fluorescent dyes or fluorescent substances in a bio-chip, when laser light is irradiated toward the bio-chip installed in a cell analysis apparatus according to one embodiment of the present disclosure.

As shown, cells stained with various fluorescent dyes may show different fluorescence detection patterns according to the irradiation of laser light of different wavelengths. For example, when irradiated with 488 nm (blue) laser light, cells stained with FITC (S910) generate fluorescence excited at approximately 520 nm (green). In addition, cells stained with PerCP or PerCP-Cy5.5 (S920) generate red fluorescence excited by both 488 nm and 638 nm laser light. Further, cells stained with DAPI (S930) generate fluorescence around 450 nm (blue light) when irradiated not with 488 nm laser light, but with a 355 nm UV laser or a 365 nm LED source.

For example, in the case of irradiating cells stained with various fluorescent dyes contained in the bio-chip 110 by the laser light sources 122, 124, 126 described with reference to FIG. 1, graph (S910) may indicate the intensity or spectral distribution of fluorescence generated by the first laser light source (122), which is a sheet-shaped laser light source having a wavelength of 488 nm. The detection results of the fluorescence generated from cells stained with FITC (S910) may be used to count the number of cells with a hemocytometer or used to extract the features of the cells. Meanwhile, graph (S920) may indicate the intensity or spectral distribution of fluorescence generated by the laser light sources (122, 124, 126) having wavelengths of 488 nm or 638 nm. Further, graph (S930) may indicate the intensity or spectral distribution of fluorescence generated by the laser light sources (122, 124, 126) having wavelengths of 355 nm or 365 nm.

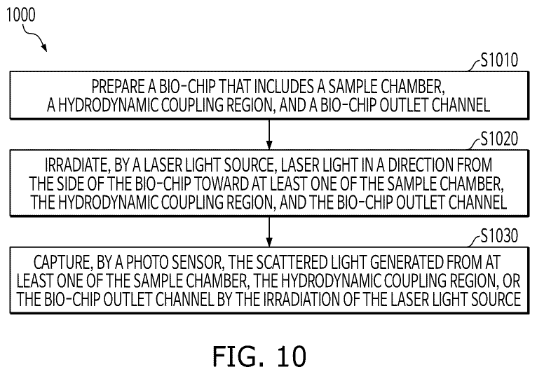

FIG. 10 is a diagram illustrating a cell analysis method 1000 using a bio-chip according to one embodiment of the present disclosure. The cell analysis method 1000 using a bio-chip may begin with step (S1010) of preparing a bio-chip that includes a sample chamber, a hydrodynamic coupling region, and a bio-chip outlet channel. When a sample is injected into the bio-chip, it is discharged into the sample chamber, and then the sample and the sheath fluid may be mixed in the hydrodynamic coupling region. The mixed or combined sample and sheath fluid may be discharged to the bio-chip outlet channel.

Next, laser light may be irradiated in a direction from the side of the bio-chip toward at least one of the sample chamber, the hydrodynamic coupling region, and the bio-chip outlet channel by the laser light source (S1020). In one embodiment, referring to FIG. 1, the first laser light source may irradiate laser light onto the sample chamber. The laser light irradiated onto the sample chamber is sheet-shaped, and may count the number of cells. Then, the sample may be discharged into the hydrodynamic coupling region and combined with the sheath fluid in the hydrodynamic coupling region. The second laser light source may irradiate laser light toward the hydrodynamic coupling region. The light irradiated onto the hydrodynamic coupling region may generate side scatter and forward scatter. Next, the combined sample and sheath fluid may be discharged into the bio-chip outlet channel. The third laser light source may irradiate laser light toward the bio-chip outlet channel. The light irradiated onto the bio-chip outlet channel may generate side scatter and forward scatter.

Finally, the scattered light generated from at least one of the sample chamber, the hydrodynamic coupling region, or the bio-chip outlet channel by the irradiation of the laser light source may be captured by a photo sensor (S1030). The forward scatter generated from the sample in the sample chamber by the first laser light source may be detected by the first photo sensor. Next, the forward scatter generated in the hydrodynamic coupling region by the second laser light source may be detected by the second photo sensor. Also, the second photo sensor may detect the mixing state of the sample and the sheath fluid in the coupling region. Lastly, the forward scatter generated in the bio-chip outlet channel by the third laser light source is detected by the third photo sensor, and the third photo sensor may detect sample characteristics such as the arrangement or flow of the sample in the bio-chip outlet channel.

The foregoing description of the present disclosure is provided to enable those skilled in the art to make or use the present disclosure. Various modifications of the present disclosure will be readily apparent to those skilled in the art, and the defined general principles of this specification may be applied to various modified examples without departing from the spirit or scope of the present disclosure. Accordingly, the present disclosure is not intended to be limited to the examples described herein, but is intended to have the broadest scope consistent with the principles and novel features disclosed herein.

Although the present subject matter has been described in terms of certain structural features and/or methodological acts, it will be understood that the subject matter defined in the appended claims is not necessarily limited to the specific features or acts described above. Rather, the specific features and acts described above are disclosed as example forms of implementing the claims.

While the present disclosure has been described in connection with certain embodiments, various changes and modifications can be made without departing from the scope of the present disclosure, as understood by those skilled in the art to which the invention pertains. Such changes and modifications should also be considered to fall within the scope of the claims attached hereto.

What is claimed is:

1. A bio-chip for cell analysis, comprising:
a sample chamber configured to hold a sample;
a first pump connected to one side of the sample chamber and configured to generate air pressure for discharging the sample in the sample chamber;
a hydrodynamic coupling region connected to the sample chamber and a sheath-fluid supply channel through which sheath fluid is supplied, configured so that the sample discharged from the sample chamber and the sheath fluid supplied through the sheath-fluid supply channel are mixed; and
a bio-chip outlet channel configured so that the mixed sample and sheath fluid are discharged from the hydrodynamic coupling region.

2. The bio-chip according to claim 1, further comprising:
a sheath-fluid chamber connected to the sheath-fluid supply channel and configured to hold sheath fluid; and a second pump connected to one side of the sheath-fluid chamber and configured to generate air pressure to discharge the sheath fluid in the sheath-fluid chamber toward the hydrodynamic coupling region through the sheath-fluid supply channel.

3. The bio-chip according to claim 2, further comprising an acoustic vibration element that generates acoustic vibrations toward the hydrodynamic coupling region.

4. The bio-chip according to claim 1, further comprising a laser light source configured to irradiate laser light toward at least one of the sample chamber, the hydrodynamic coupling region, and the bio-chip outlet channel.

5. The bio-chip according to claim 4, wherein the laser light source comprises:
a first laser light source for irradiating sheet-shaped laser light toward a side surface of the sample chamber;
a second laser light source for irradiating laser light toward a side surface of the hydrodynamic coupling region; and
a third laser light source for irradiating laser light toward a side surface of the bio-chip outlet channel.

6. The bio-chip according to claim 5, wherein the first laser light source comprises:
a laser diode that generates laser light; an aspheric lens that refracts the laser light; and
a cylinder lens configured to converge the laser light and irradiate the sheet-shaped laser light toward the sample chamber.

7. The bio-chip according to claim 1, wherein the bio-chip outlet channel is configured such that at least part of its width narrows in the direction in which the sample is discharged.

8. The bio-chip according to claim 1, further comprising a photo sensor configured to capture scattered light generated from at least one of the sample chamber, the hydrodynamic coupling region, and the bio-chip outlet channel.

9. The bio-chip according to claim 8, wherein the photo sensor comprises:
a first photo sensor for detecting forward scatter generated by the sheet-shaped light irradiated onto the sample in the sample chamber;
a second photo sensor for detecting a coupling state of the sheath fluid and the sample in the hydrodynamic coupling region or detecting forward scatter generated by laser light; and
a third photo sensor for detecting the sample discharged through the bio-chip outlet channel or detecting forward scatter generated by the laser light.

10. A cell analysis method using a bio-chip, comprising:
supplying a sample to a sample chamber;
supplying a sheath fluid to a sheath-fluid chamber;
discharging the sample in the sample chamber to a hydrodynamic coupling region by a first pump;
discharging the sheath fluid in the sheath-fluid chamber to the hydrodynamic coupling region by a second pump;
discharging the mixed sample and the sheath fluid from the hydrodynamic coupling region by a bio-chip outlet channel; and
detecting the number of cells or the cell status in at least one of the sample chamber, the hydrodynamic coupling region, and the bio-chip outlet channel by a laser light source and a photo sensor.

11. A cell analysis device using a bio-chip, comprising:
a bio-chip including a sample chamber configured to hold a sample;
a hydrodynamic coupling region connected to the sample chamber and a sheath-fluid supply channel, configured so that the sample discharged from an outlet of the sample chamber and the sheath fluid supplied through the sheath-fluid supply channel are mixed; and
a bio-chip outlet channel configured so that the mixed sample and the sheath fluid in the hydrodynamic coupling region are discharged;
one or more laser light sources configured to irradiate laser light from the side of the bio-chip toward at least one of the sample chamber, the hydrodynamic coupling region, and the bio-chip outlet channel; and
one or more photo sensors configured to capture scattered light generated from at least one of the sample chamber, the hydrodynamic coupling region, and the bio-chip outlet channel by irradiation of the laser light.

12. The cell analysis device according to claim 11, wherein the bio-chip further comprises a sheath-fluid chamber connected to the sheath-fluid supply channel and configured to hold sheath fluid.

13. The cell analysis device according to claim 11, further comprising an LED light source configured to irradiate light toward an upper surface of the bio-chip, and an image sensor located on a lower surface of the bio-chip.

14. The cell analysis device according to claim 13, further comprising a pinhole positioned between the bio-chip and the LED light source, configured to limit the range of light irradiation.

15. The cell analysis device according to claim 13, further comprising one or more light receiving elements configured to detect side scatter generated on the upper surface of the bio-chip by the one or more laser light sources.

16. The cell analysis device according to claim 13, wherein the image sensor is configured to detect side scatter or fluorescence generated on the lower surface of the bio-chip by the one or more laser light sources, or to detect a dark-field image, a bright-field image, or an absorption image generated on the lower surface of the bio-chip by the light irradiated from the LED light source.

17. A cell analysis method using a bio-chip, comprising:
preparing a bio-chip that includes a sample chamber configured to hold a sample, a sheath-fluid chamber configured to hold the sheath fluid, a hydrodynamic coupling region connected to both the sample chamber and the sheath-fluid chamber so that the sample and the sheath fluid discharged from the sample chamber and the sheath-fluid chamber, respectively, are mixed, and a bio-chip outlet channel configured so that the sample and the sheath fluid mixed in the hydrodynamic coupling region are discharged;
irradiating laser light from the side of the bio-chip toward at least one of the sample chamber, the hydrodynamic coupling region, and the bio-chip outlet channel by one or more laser light sources; and
capturing scattered light generated from at least one of the sample chamber, the hydrodynamic coupling region, and the bio-chip outlet channel due to the irradiation by the one or more laser light sources by one or more photo sensors.
